(19) United States
(12) Patent Application Publication
(10) Pub. No.: US 2004/0216157 A1
(43) Pub. Date: Oct. 28, 2004

(54) System and method for advertising purchase verification

(76) Inventors: Richard Shain, Jamaica Plain, MA (US); Pamela Shain Rosen, Brookline, MA (US); Sean Murphy, Middleboro, MA (US)

Correspondence Address: LAHIVE & COCKFIELD, LLP., 28 STATE STREET, BOSTON, MA, 02109, US

(21) Appl. No.: 10/423,628

(22) Filed: Apr. 25, 2003

(51) Int. Cl. H04N 7/025; H04N 7/10; G06F 3/00; H04N 5/445; G06F 13/00

(52) U.S. Cl. 725/42; 725/32

(57) ABSTRACT

A system and method allowing the management of large-scale media campaigns involving multiple advertisements being presented over one or more media outlets in one or more markets is disclosed. The programmatic matching of presented advertisements to purchased advertisements reduces manual matching errors. A narrowest first algorithm saves significant time over manual matching methods and is scalable to handle media campaigns of differing sizes. Once matched, the results are posted against media ratings for an applicable time period or other measurements. Multiple types of reports indicating the level of satisfaction of a media campaign are generated automatically from the application of the measurements or media ratings to the matched data.

### FIELD OF THE INVENTION

The illustrative embodiment of the present invention relates generally to advertising and more particularly to an advertising purchase verification system integrating measurement data to determine the fulfillment of a media campaign.

### BACKGROUND

Advertisements appearing on radio, television and other media outlets are often part of a widespread media campaign. The media campaign may require a number of different parameters be fulfilled. For example, advertisements may be presented across multiple media outlets, and may appear in multiple versions and as sequential advertisements. Advertisements may be presented as video advertisements, audio advertisements, written or photo advertisements in written periodicals, in electronic form in computer advertisements, and other forms. The advertisements may be specified to run at certain times on certain channels, air during specified shows, may be restricted from appearing during other shows, and may appear in some media markets but not others. The different parameters controlling the viewing of the advertisement are first determined during the creation of the media campaign and the parameters then form the basis for the advertising buy from the media outlets. Often times, a media campaign such as a television advertising campaign, will run on multiple stations in multiple markets. As part of the order/purchase of the advertising time from the media outlets, certain guarantees in the form of rating numbers are made in return for the order/purchase. The media outlets guarantee a certain number of viewers in exchange for receiving a fee for the presented advertisement.

Unfortunately, the verification of the fulfillment of the guaranteed ratings for the advertisements is often quite difficult. The media outlets report on which advertisements ran including information such as placement, time, size or length and location. The ratings values for various time slots are determined by a third party ratings provider such as Nielsen (which provides TV viewer ratings ), ABC (which provides print circulation figures) and Arbitron (which provides radio listener ratings). The task of determining which advertisement went with which media campaign falls to the advertising purchaser or their agent. The advertising purchaser is required to cross-reference the information from the media outlets with media “buy” data (a media “buy” is the order/purchase of an advertisement slot from a media outlet), and then post the rating or other proof of performance for the applicable time period. The purchaser of the advertisement must also verify that all of the parameters forming part of the media buy are satisfied. The difficulty of this task scales up exponentially with increases in the number of advertisements, media outlets and media markets implementing the campaigns.

### BRIEF SUMMARY OF THE INVENTION

The illustrative embodiment of the present invention programmatically matches media invoices detailing the media outlet presentation of the advertisements against purchased media advertisements. Satisfaction of parameters specified in a “media campaign” are checked as part of the verification process. The media ratings for an applicable time period or other measurement, parameters, or tracking data may be posted against the matched or unmatched advertisements. The rating value for the time period in which the advertisement was run (or other measurement or tracking data) may be compared against any promised value specified by the media outlet. Differences in actual versus promised values may be accommodated by the media outlets. The present invention also allows the programmatic generation of multiple types of reports breaking down media ratings or other measurement data by particular demographics, psychographics or other factors.

In one embodiment, an advertising purchase verification system uses a method to programmatically match at least one advertisement listed in a media invoice from a media outlet with a reference to a purchased media advertisement. The reference includes parameters indicating how the advertisement should be presented by the media outlet. The parameters are specified for the advertisement as part of a media campaign. The matching verifies the fulfillment of certain parameters associated with the purchased advertisement. Media ratings for applicable time periods are posted against matched advertisements. The fulfillment of the media campaign is determined programmatically by analyzing the matched advertisements and the corresponding ratings.

In another embodiment, an advertising purchase verification system uses a method to validate the fulfillment of media campaigns. An electronic device receives data referencing purchased media advertisements, an invoice from a media outlet listing presented advertisement details, and media ratings for applicable time periods. The presented advertisement is programmatically matched to the purchased advertisements. The media ratings are posted to the matched data. The posted ratings are examined to compare promised media ratings to delivered media ratings.

In one embodiment, an advertising purchase verification system includes at least one invoice from a media outlet indicating the advertisements presented by the media outlet during a specified time period. The system also includes data referencing an advertisement purchased from a media outlet. The system additionally includes media ratings for at least one time period which indicate the size of the audience for a presented advertisement. In addition, the system includes an electronic device using software which accepts as input the invoice(s), data and media rating(s). The software matches details contained in the invoices to the advertisements listed in the data Media ratings are posted by the software to completed matches.

### BRIEF SUMMARY OF THE DRAWINGS

FIG. 1 depicts and environment suitable for practicing the illustrative embodiment of the present invention;

FIG. 2 is a flow chart of the overall sequence and steps that are practiced by the illustrative embodiment of the present invention to reconcile records of presented advertisements against purchased media advertisements;

FIG. 3 is a flow chart depicting the sequence of steps used by the illustrative embodiment of the present invention in implementing a narrowest-first algorithm used to match presented advertisements against purchased media;

FIG. 4 is a flow chart of the sequence of steps performed by the illustrative embodiment of the present invention to generate reports indicating the degree of satisfaction of the parameters or extent of discrepancies specified in a media campaign.

### DETAILED DESCRIPTION

The illustrative embodiment of the present invention allows the management of large-scale media campaigns involving multiple advertisements being presented through one or more media outlets in one or more markets. The programmatic matching of presented advertisements to ordered/purchased advertisements cuts down on manual verification errors. Additionally, the use of a narrowest first algorithm saves significant time over manual matching methods and is scalable to handle media campaigns of differing sizes. Once matched, the results can be posted against media ratings for an applicable time period thereby allowing a breakdown of advertisements by demographic viewership and other factors. Multiple types of reports indicating the level of satisfaction of a media campaign may be generated automatically from the application of the media ratings or other third party measurement or tracking data to the matched data. Values for any credits or other compensation due from a media outlet's failure to satisfy the parameters associated with the purchased advertisement (which are dictated by the media campaign) may be programmatically calculated. For the purpose of the description contained herein, the terms “order(ed)” and “purchase(ed)” are used interchangeably in that ordered advertisements include advertisements subsequently paid for, and purchased advertisements include ordered advertisements prior to payment.

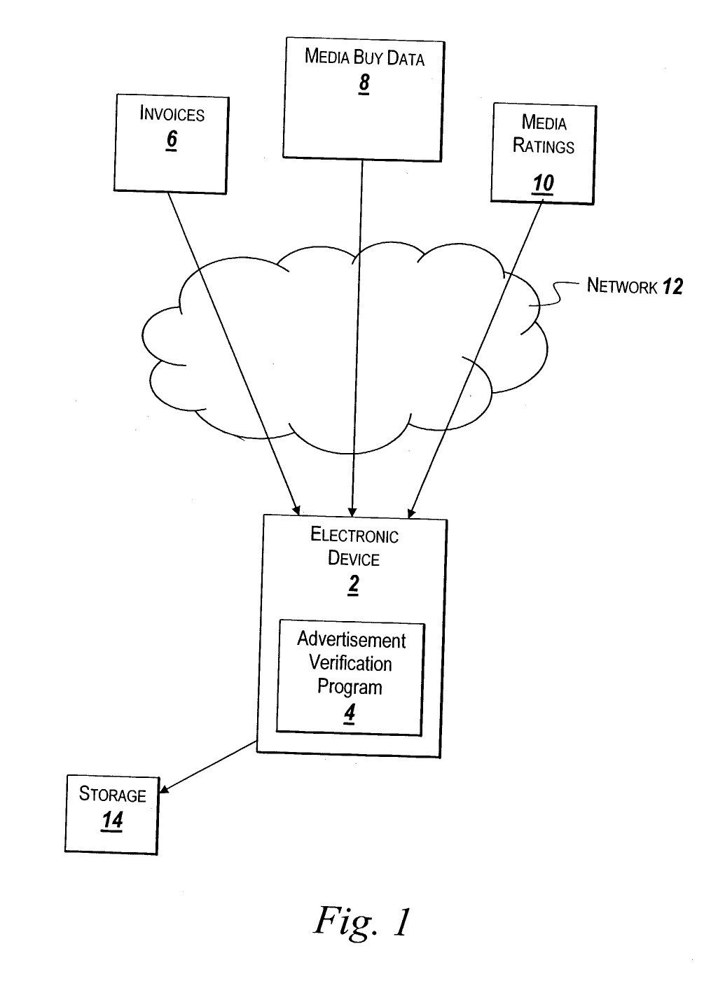

FIG. 1 depicts an environment suitable for practicing the illustrative embodiment of the present invention. An electronic device 2 includes an advertisement verification program 4. The electronic device 2 may be a desktop computer system, laptop, client workstation, server, network-attached device, PDA, or other electronic device equipped with a processor. The electronic device 2 imports at least one invoice 6 from media outlets. The invoices 6 indicate the advertisements that were presented by a particular media outlet during a particular time period. The media outlet may be a television station, radio station, written periodical, Internet publisher or some other entity which presents advertisements. The invoices 6 are imported into the advertisement verification program 4. Also used as input for the advertisement verification program 4 are media buy data 8 and media ratings 10. The media buy data 8 lists advertisements purchased by a buyer which were scheduled to be presented by at least one media outlet. The media buy data 8 also includes media campaign parameters specified in the buy. Those skilled in the art will recognize that the media buy data 8 may be represented in a number of different ways other than lists, such as being referenced indirectly by pointers, and may be stored in a number of different locations. The media ratings represent the approximation of viewership/listenership/readership for a particular time period for a particular media outlet's advertising presentation.

The invoices 6, media buy data 8, and media ratings 10 may be transmitted to the electronic device 2 over a network 12. Those skilled in the art will recognize that other forms of inputting the data into the advertisement verification program 4 that do not utilize a network are also possible within the scope of the present invention. For example, the invoices 6, media buy data 8, and media ratings 10 may be directly input into the electronic device 2 via some form of removable permanent memory such as a CD ROM. The invoices 6, media buy data 8, and media ratings 10 may be stored on a form of permanent storage 14 accessible to the electronic device 2. Those skilled in the art will recognize that the storage 14 may be located on the electronic device 2 or otherwise accessible to the electronic device 2. Additionally, the invoices 6, media buy data 8, and media ratings 10, may initially be located on the electronic device 2 prior to being used as input for the advertisement verification program 4.

The illustrative embodiment of the present invention utilizes a number of third party data sources. Invoices 6 are provided by the media outlets from which the advertisements were purchased. Media ratings 10 are provided by third party companies such as Nielsen and Arbitron. The data may be provided in a number of different computer formats including a comma delimited format. The invoice data may be provided by a third party purchaser of the advertisement who is having an outside party run the advertising verification program 4, or may be run by the advertising purchaser performing verification in-house. Once the various data has been acquired, the advertising verification program 4 may be used to analyze the data after matching and posting. Those skilled in the art will recognize that other types of measurement data in addition to or instead of, ratings measurements may be used to determine the satisfaction of media campaign objectives. For example, third party measurement data such as “on-air broadcast verification” data and competitive advertising data may be used. Similarly, instead of invoices listing presented advertisements from a media outlet, third party data from research or advertising monitoring companies may also be used without departing from the scope of the present invention.

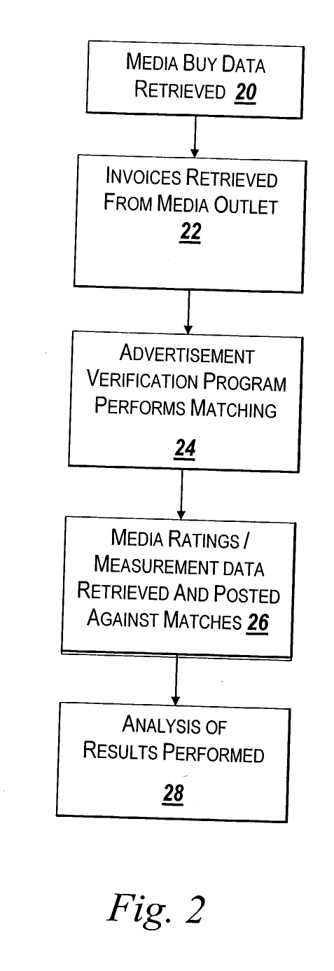

FIG. 2 is a flow-chart of the overall sequence of steps performed by the present invention to match and post data and generate reports. The sequence begins when the media buy data 8 is retrieved from a storage location 14 (step 20). The invoices are retrieved from the media outlet (step 22). The invoices 6 may include line items listing individual presented ads. After retrieval of the invoices 6 and media buy data 8, the advertisement verification program 4 matches the invoices 6 to the media buy data 8 (step 24). Once the matching algorithm has performed and matched the invoice data 6 with some of the parameters listed in the media buy data 8, the media ratings 10 (or other measurement data) are retrieved for the applicable time period(s) and then posted against the matched items (step 26). The analysis of results is then performed involving the generation of multiple types of reports analyzing the posted media ratings data (or other measurement data)(step 28). By determining the degree to which the parameters of the advertisements were satisfied, the monetary or other impact of the overall media campaign may be evaluated.

The illustrative embodiment of the present invention uses a narrowest-first algorithm to perform matching between purchased advertisements and their associated parameters and advertisements run by the media outlets. The algorithm applies a set of rules to the verification process to determine how closely the goals of the media campaign are being fulfilled. Invoices 6 for the ads in a media campaign are collected and individually compared against the media buy data 8. The invoices 6 list particular advertisements and certain parameters associated with a media campaign. The media buy data 8 also may include a promised rating value parameter guaranteed by the media outlet. In the event the rating value is not achieved by the particular advertisement or the other parameters are not totally satisfied, the media outlet may satisfy the guarantee by providing additional ads or other compensation.

The media campaign parameters include items such as when the advertisement should be run, which programs the advertisement should be associated with, which programs the advertisement should not be associated with, the frequency with which the advertisement may be run both with respect to other broadcasts of the advertisement and broadcasts of national advertisements for similar products, acceptable lead-in and lead-out times around a particular program/time-slot, the markets for the advertisement, the times in which the advertisement may be run or not run (times in which the campaign should go on “hiatus”), separation from competitive advertisements, placement location and other similar rules controlling when and how the advertisement should be run. Each purchased advertisement listed in the media buy data 8 is compared against an invoice line item put out by the media outlet. The invoice line items list each of the advertisements that were presented by the media outlet providing the data. The advertisement verification program 4 compares the details included in the invoice line items against the parameters listed for an advertisement in the media buy data 8 to see if the presented advertisement matches one or more purchased advertisements. If an invoice line item of a presented advertisement matches only one, purchased advertisement in the media buy data 8, the presented advertisement is considered matched to the purchased advertisement. If the presented advertisement matches more than one purchased advertisement, the other matches are noted and temporarily stored. The other ads in the campaign are similarly examined adjusting the comparison pool for those line items which have already been considered matched.

Following the examination of all of the advertisements in the invoice 6, and the removal of all of the single matched items from the comparison pool, the process iterates and begins again with a smaller comparison pool. The presented advertisement with the least number of matches remaining is assigned a match, the match is removed from the comparison pool, and the next unmatched presented advertisement is compared against the adjusted comparison pool. This process continues until all of the presented advertisements listed in the invoice 6 have been matched or are indicated as having failed to match at least one purchased advertisement listed in the media buy data. Software logic is built into the advertisement verification program 4 to indicate when the assignment of a presented advertisement listed an invoice 6 to a purchased advertisement listed in the media buy date 8 which is one of multiple possibilities, would prevent other not yet matched advertisements from being assigned a match. In the case of such a conflict, a different match is assigned to the invoice from among the multiple possibilities. Any unmatched items at the end of the matching process are flagged and used as the basis for a report listing non-matched advertisements. The advertising verification program 4 may be configured to suggest near matches based on the degree to which parameters were satisfied. The unmatched advertisements may then be manually matched by a user to the nearest available match taking into account the advertising verification program's suggestions. Additionally, any purchased advertisements which are not run at all are also noted and may also form the basis of a report.

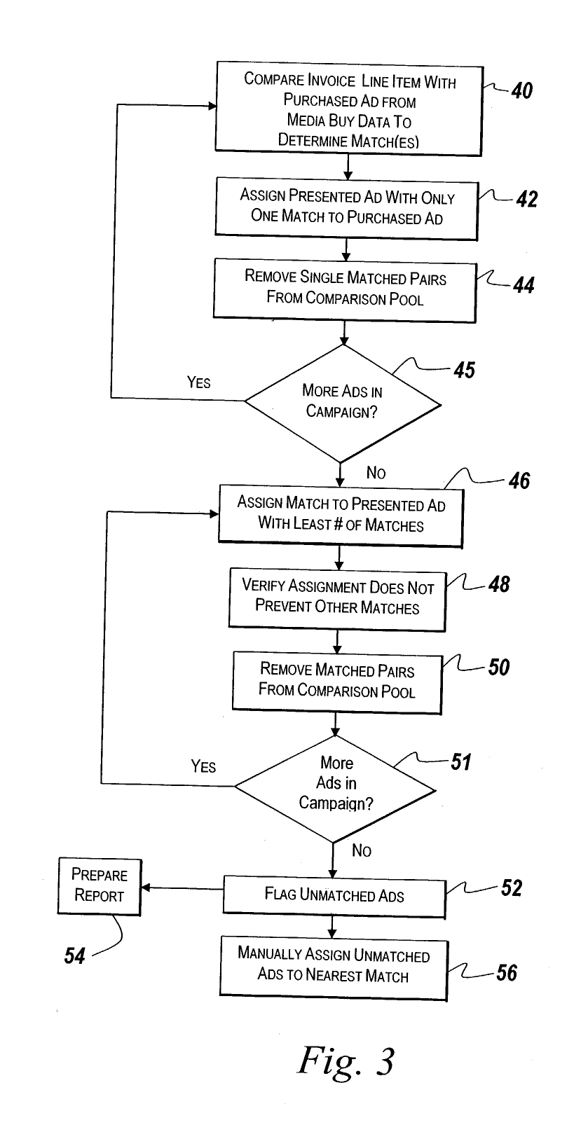

FIG. 3 is a flow chart of the sequence of steps followed by the illustrative embodiment of the present invention to apply a narrowest-first algorithm to matching the presented advertisements listed in the invoice 6 with the purchased advertisements listed in the media buy data 8. The sequence begins by comparing a presented ad listed in the invoice line items with purchased advertisements listed in the media buy data 8. Any match or matches for the presented advertisement are determined (step 40). Each presented advertisement which matches only one purchased advertisement listed in the media buy data 8 is assigned as a match to that purchased advertisement (step 42). Single matched pairs are then removed from the comparison pool prior to any additional comparisons being performed (step 44). In other words, the purchased advertisement in the media buy data is indicated as not being available for matching purposes for additional presented advertisements listed in the invoice line items. A determination is then made as to whether or not there are more presented advertisements listed in the invoice line items (step 45). If there are more advertisements listed in the invoice line items, the process iterates and again compares the next presented advertisement against the adjusted pool of purchased advertisements listed/referenced in the media buy data 8 (step 40), the pool having been adjusted to remove a previously matched item. The process continues until all of the ads in the invoice line items have been compared against the media campaign represented in the media buy data with any single matches being removed from the comparison pool and any multiple matches being noted.

Once all of the single matches for all of the advertisements listed in the invoice 6 have been identified and the comparison pool adjusted accordingly, the remaining presented advertisements are then matched to the media buy data. The first remaining advertisement listed in the invoice 6 which has the least number of matches in the media buy data 8 is then assigned to one of the possible matches (step 46). The assignment to one of the matches is verified to ensure that the assignment of the presented advertisement to one of the possible matches does not prevent other advertisements in the invoice 6 which have not yet been matched from being matched (step 48). In the event that the assignment does not prevent other unmatched advertisements from being matched, the match is finalized and removed from the comparison pool (step 50). If the assignment of the first match is found to interfere with the matching possibility of another advertisement, a different match from among the possibilities is assigned which does not cause a conflict. If there are additional ads listed in the invoice 6 which have multiple matches, the process iterates (step 51) and compares the next presented advertisement with the least number of matches to the available purchased advertisements in the diminished comparison pool (step 46). Each subsequent match reduces the available pool of purchased advertisements against which the subsequent ads in the invoice can be compared. When all of the presented advertisements possessing matches have been matched, any unmatched ads are flagged and noted (step 52). The unmatched ads are used to generate an unmatched advertisement report for the media purchaser (step 54). Any unmatched ads may be manually assigned by the user of the advertisement verification program 4 to the nearest available match in the media buy data 8. Those skilled in the art will recognize that the matching process may involve multiple invoices 6 from multiple media outlets and may further involve matching only a subset of the parameters associated with an advertisement listed in the media campaign.

The advertising verification program 4 is able to generate a number of different types of reports in addition to the non-matching advertisement report mentioned above. The reports include a Posting Analysis report which indicates the estimated ratings point for an advertisement versus the actual rating points for the time period in which the advertisement was presented by the media outlet. A Double Spotting report may also be generated which list multiple spots that air on the same day in the same program, a outcome that is usually not desirable. The reports may utilize parameters set by the user to generate the different types of reports. For example, a Separation report indicates spots which air less than N minutes apart where the variable N is provided by the user. A Hiatus report lists the spots which have aired outside a range of times during a day or within a day excluded from a particular campaign. A Restricted Programs report lists spots which have aired against programs which were on the restricted list for the campaign in contravention to the invoice. A Cut-Off report lists broadcasting spots which air outside of allowable air times as indicated by the original arrangement between the advertising purchaser and the media outlet. An Underdelivery report lists shortfalls of actual versus estimated viewership. A Size Discrepancy report notes incorrect sizes or lengths of ads. A Stripping report lists the number of advertising spots which aired outside of the minimum/maximum order limits for a broadcast week. For example, a client may specify that Monday through Friday no more than five spots should be aired. If six or more spots air between Monday and Friday the sixth spot would be a violation of the stripping guideline contained in the original advertising agreement. A Traffic report summarizes any advertisements which air outside of particular date or time ranges in a campaign. These may form the basis for later negotiation with the media outlet either directly by the media purchaser or through a third party representative such as an advertising agency.

Other reports may also be generated by the present invention. A Fair and Equitable distribution report lists the distribution of spots within a program for a time range. For example, an ideal distribution within a time range might be that for a one hour program airing between 8:00 and 9:00, one third of the ads aired between 8:00 and 8:19, one third between 8:20 and 8:39, and one third between 8:40 and 8:59. A Lead-in report lists the spots, which air within a lead in prior to a program's air time. The interval is typically defined as two minutes but may be otherwise specified. The reports may also breakdown advertisement spots by the part of the day. The TRP Analysis by Daypart report list the difference between estimated rating points and actual rating points broken down by the part of the day or other criteria. The TRP Analysis by Market report lists the ratio of estimates to actual TRPs' by market share. The Daypart Average Rating Analysis report lists the total ratings divided by the number of spots that aired in a given daypart or may list the actual rating of a presented advertisement compared to a specified average rating parameter. The information accumulated by the advertisement verification program 4 may also be used to generate a dollar spending analysis report. The Dollar Spending Analysis report is a comparison of the dollars budgeted versus the final buy versus the invoice broken down by daypart or time period. A Must Buy report lists programs or times the client indicated must be purchased that did not, in fact, have a matching spot. A Roadblock report may summarize the invoice data put out by the media outlet to list any roadblock for the media outlet. A roadblock is the purchase of specific airtime and date for an entire market such that all spots air at a particular time on the same date. A Network Duplication report lists any local spots which aired during the same program as network spots for a similar product. For example, a local Ford auto dealer airing spots during the same time period as a national Ford campaign. A Preferred Program report gives a list of programs specified by the advertising purchaser and shows what spots aired against the preferred programs. A Program Name Discrepancies report lists the spots for which the program name from the final buy differed from the program name in research data (such as Nielsen). Those skilled in the art will recognize that there are a number of different types of reports in addition to those mentioned here that may be generated using the information gathered and generated by the advertisement verification program 4.

The reports generated by the illustrative embodiment of the present invention may be stand-alone reports or may be interrelated. Report settings may be specified so that identified issues are not double counted in multiple reports. When preventing double counting, the identified issues may be prioritized so that they are assigned to the report that most closely corresponds to the issue or based on other client and user specifications. The reports may also be prioritized based on client and user specifications.

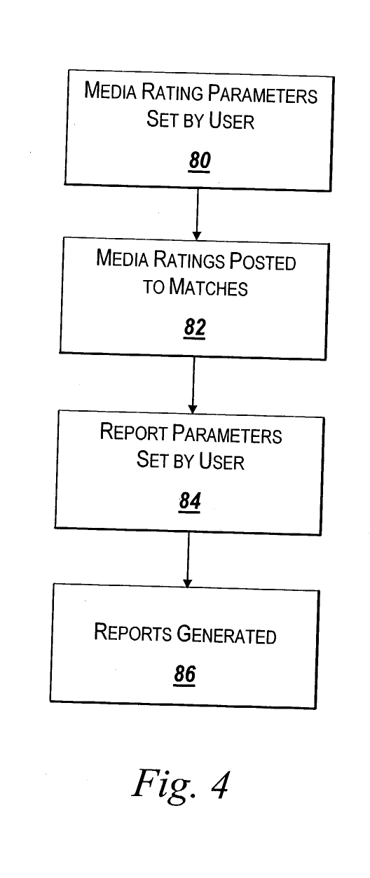

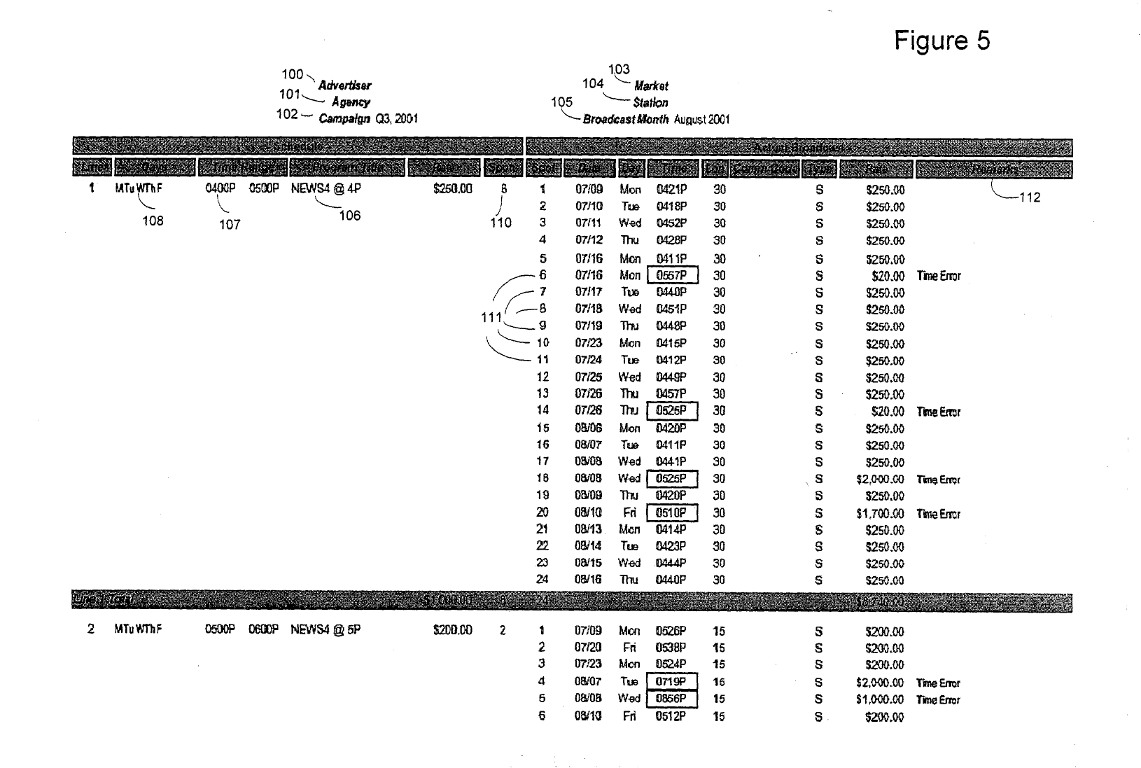

FIG. 4 is a flow chart depicting the sequence of steps performed by the illustrative embodiment of the present invention to generate reports. The sequence begins with the rating parameters being set by the user of the advertisement verification program 4 (step 80). The rating parameters may indicate various subcomponents of overall advertising ratings, such as a demographic breakdown on the basis of age or sex of the viewership/listenership/readership being exposed to an advertisement. The appropriate ratings based on the user set parameters may then be posted to the matches that were determined by the advertisement verification program 4 (step 82). The user of the advertisement verification program 4 sets report parameters and indicates the type of reports to be generated (step 84). The reports are then generated by the advertisement verification program 4 (step 86).

FIG. 5 depicts a “matching” report, one of the many reports generated by the illustrative embodiment of the present invention. The matching report lists the advertiser 100, agency 101, campaign 102, market 103, station 104 and broadcast month 105. The displayed matching report is grouped by program name 106 and its associated time range 107 and date 108. The report includes the number of spots required for the campaign 110. A plurality of spots 111 matching the schedule detail are also listed along with a remarks section 112 indicating a reason any of the listed spots do not conform to the schedule.

The illustrative embodiment of the present invention not only identifies issues, it also calculates the value and/or rating and/or effect of the issue based on criteria input by a user. The criteria may relate to cost, rating or similar factors. The criteria is programmatically compared to the identified issue and the results are then presented to a user.

Those skilled in the art will recognize that while the examples contained herein have been focused on advertising and media buys, the illustrative embodiment of the present invention may be used to compare many other types of data sources, such as buys and proof of performance, on-air verification data, and competitive occurrence data. Additional requirements such as buying guidelines and purchase instructions may be overlaid on the compared data to further filter the results.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Although reference has been made herein to a narrowest-first algorithm used to perform matching, those skilled in the art will recognize that other algorithms may be used without departing from the scope of the present invention. Similarly, practitioners of the art will realize that the sequence of steps and architectures depicted in the figures may be altered without departing from the scope of the present invention. The illustrations contained herein are singular examples of a multitude of possible depictions of the present invention, and should be considered accordingly.

We claim:

1. In an advertising purchase verification system, a method, comprising the steps of:
matching programmatically at least one advertisement listed in an invoice issued by a media outlet with a reference to a purchased media advertisement, said reference including parameters indicating how said purchased media advertisement should be presented, said parameters specified in a media campaign including said purchased media advertisement, said matching verifying the fulfillment of said parameters by an advertisement listed in said invoice;
posting a media rating for an applicable time period against the matched advertisement;
determining programmatically the fulfillment of said media campaign through the analysis of at least one matched advertisement and the corresponding media rating.

2. The method of claim 1 wherein said media outlet is one of a television station, radio station, written periodical publisher, and Internet publisher.

3. The method of claim 1 wherein said matching is performed using a narrowest-first algorithm, said narrowest-first algorithm applying a set of rules to determine the fulfillment of said parameters included in said reference by an advertisement run by said media outlet.

4. The method of claim 1 wherein said parameters for said media campaign specify a hiatus, said hiatus indicating at least one of dates and times said purchased media advertisement is not to run.

5. The method of claim 1, comprising the further steps of:
programmatically computing a value to be credited by said media outlet to a purchaser of said purchased media advertisement for failing to fulfill parameters specified in said reference.

6. The method of claim 1 wherein said reference is a media buy order.

7. The method of claim 1 wherein said programmatic matching determines an advertisement presented by said media outlet does not fulfill said parameters.

8. The method of claim 1 wherein said programmatic matching determines said purchased media advertisement was not run by said media outlet.

9. In an advertising purchase verification system, a method, comprising the steps of:
receiving with an electronic device data referencing at least one purchased media advertisement, at least one invoice from a media outlet, said invoice indicating advertisements presented by said media outlet during a specified time period, and media ratings for at least one time period, said media ratings applicable to said purchased advertisement presented by said media outlet;
matching programmatically at least one presented advertisement indicated in said invoice with a purchased advertisement referred to in said data;
posting said media rating for an applicable time period against the matched presented advertisement; and
comparing said media rating for the applicable time period against a parameter for said advertisement, said parameter representing a rating value promised to a purchaser of said advertisement.

10. The method of claim 9 wherein said programmatic matching is performed using a narrowest-first algorithm.

11. The method of claim 9, comprising the further step of:
identifying programmatically any presented advertisement indicated by said at least one invoice that was not matched to at least one purchased advertisement referenced by said data.

12. The method of claim 11, comprising the further step of:
indicating programmatically to a user the closeness of matching of said non-matching presented advertisement to said at least one purchased advertisement, said closeness of matching based upon the degree of satisfaction of said parameters.

13. The method of claim 11, comprising the further step of:
manually assigning non-matched presented advertisements to near matches.

14. The method of claim 9, comprising the further step of:
generating at least one report for analyzing the comparisons of media ratings to at least one presented advertisement.

15. The method of claim 14 wherein said report is at least one of a Posting Analysis report, Double Spotting report, Separation report, Hiatus report, Restricted Program report, Cut-off report, Underdelivery report, Stripping report, Traffic report, Fair and Equitable distribution report, Lead-in report, TRP Analysis by Daypart report, TRP Analysis by Market report, Daypart Average Rating, Analysis report, Dollar Spending Analysis report, Must-Buy report, Roadblock report, Network Duplication report, Preferred Program report, and Program Name Discrepancy report.

16. The method of claim 14 wherein said report distinguishes viewers of said presented advertisement on the basis of at least one of demographics or psycho graphics.

17. The method of claim 9, comprising the further step of:
performing said programmatic matching using parameters associated with a media campaign.

18. The method of claim 9, comprising the further steps of:
determining that a media rating for an advertisement promised by said media outlet was not satisfied by the presented advertisement; and
receiving an advertising credit from said media outlet as a result of said media rating not being satisfied.

19. An advertising purchase verification system, comprising:
at least one invoice, said invoice indicating the advertisements presented by a media outlet during a specified time period;
data referencing a purchased advertisement, said advertisement purchased from said media outlet;
media ratings for at least one time period, said media ratings indicating the audience size for a presented advertisement; and
an electronic device, said electronic device including software using as input said at least one invoice, said plurality of media ratings and said data referencing said purchased advertisements, said software programmatically matching said presented advertisements indicated in said at least one invoice with said purchased advertisements indicated in said data and posting said ratings value to the completed matches.

20. The system of claim 19 wherein said software generates a report based on the results of posting said ratings value to the completed matches.

21. The system of claim 20 wherein said report includes at least one of a Posting Analysis report, Double Spotting report, Separation report, Hiatus report, Restricted Program report, Cut-off report, Underdelivery report, Stripping report, Traffic report, Fair and Equitable distribution report, Lead-in report, TRP Analysis by Daypart report, TRP Analysis by Market report, Daypart Average Rating aAnalysis report, Dollar Spending Analysis report, Must-Buy report, Roadblock report, Network Duplication report, Preferred Program report, and Program Name Discrepancy report.

22. The system of claim 19 wherein said media ratings are at least one of Nielsen ratings and Arbitron ratings.

23. The system of claim 19 wherein said software uses a narrowest-first algorithm to match at least one presented advertisement indicated by said at least one invoice to said purchased advertisements .

24. In an advertising purchase verification system, a medium holding computer-executable steps for a method, said method comprising the steps of:
receiving with an electronic device data referencing at least one purchased media advertisement, at least one invoice from a media outlet, said invoice indicating advertisements presented by said media outlet during a specified time period, and media ratings for at least one time period, said media ratings applicable to said purchased advertisement presented by said media outlet;
matching programmatically at least one presented advertisement indicated by said invoice with a purchased advertisement referred to in said data;
posting said media rating for an applicable time period against the matched advertisement; and
comparing said media rating for the applicable time period against a parameter for said advertisement, said parameter representing a rating value promised to a purchaser of said advertisement.

25. The medium of claim 24 wherein said method comprises the further steps of:
determining programmatically that at least one presented advertisement indicated in said invoice does not match any advertisement indicated in said data referencing at least one purchased advertisement; and
indicating programmatically to a user the closeness of matching of said non-matching presented advertisement to said at least one purchased advertisement, said closeness of matching based upon the degree of satisfaction of said parameters.

26. The medium of claim 24, wherein said method comprises the further step of:
generating a report identifying said non-matching presented advertisement.

27. The medium of claim 24 wherein said programmatic matching is performed using a narrowest first algorithm.

28. The medium of claim 24 wherein said media rating is at least one of a Nielsen rating and Arbitron rating.

29. In an advertising purchase verification system, a method, comprising the steps of:
matching programmatically a presented advertisement listed in a invoice issued by a media outlet with at least one reference to a purchased media advertisement, said reference including parameters indicating how said purchased media advertisement should be presented, said parameters specified in a media campaign including said purchased media advertisement, said matching verifying the fulfillment of said parameters by an advertisement listed in said invoice;
posting a measurement against the matched advertisement;
determining programmatically the fulfillment of said media campaign through the analysis of at least one matched advertisement and the posted measurement.
